(19) United States
(12) Patent Application Publication
(10) Pub. No.: US 2008/0286175 A1
(43) Pub. Date: Nov. 20, 2008

(54) Reformer for converting biomass into synthesis gas

(75) Inventors: William L. Manning, Osawatomie, KS (US); Michael J. Goff, Kansas City, MO (US)

Correspondence Address: F. LINDSEY SCOTT;LAW OFFICE OF F. LINDSEY SCOTT, 2329 COIT ROAD, SUITE B, PLANO, TX, 75075-3796, US

(73) Assignee: Black & Veatch Corporation

(21) Appl. No.: 11/803,189

(22) Filed: May 14, 2007

(51) Int. Cl. B01J 19/00

(52) U.S. Cl. 422/198

(57) ABSTRACT

A tubular reformer wherein biomass is treated in the presence of steam in a tubular reactor at elevated temperatures to convert the biomass and steam into synthesis gas, comprising primarily of carbon monoxide, hydrogen and carbon dioxide.

### FIELD OF THE INVENTION

The present invention relates to a tubular reformer wherein biomass is treated in the presence of steam in the tubular reformer at elevated temperatures to convert the biomass and steam into synthesis gas comprising primarily carbon monoxide, hydrogen, and carbon dioxide.

### BACKGROUND OF THE INVENTION

In recent years, there has been considerable interest in producing synthetic fuels for automobiles, power plants, and a multitude of other uses. Many of these processes have relied upon fermentation processes to produce alcohols, such as ethanol, from grain products, such as corn. It is well known that ethanol can also be produced by fermentation processes from materials such as sugar cane, sugar beets, and many other agricultural products. Such materials contain sugars that are readily converted by fermentation into ethanol. Unfortunately, the amount of grain products produced in the world and in many industrialized countries (such as the United States) is not sufficient to produce enough fuel to replace substantial amounts of gasoline for cars or other fuel purposes and to supply food for consumption.

Accordingly, considerable attention has recently been directed to the development of processes for the production of ethanol from other materials, including cellulosic materials and biomass of almost any type, such as lignite, coal, wood, bagasse, rice hulls, straw, kenaf (a weed), sewer sludge, motor oil, oil shale, creosote, pyrolysis oil from a tire pyrolysis plant, railroad ties, dried distiller grains, cornstalks and cobs, or animal excrement. The use of these waste and non-food carbonaceous materials to produce synthesis gas enables the production of ethanol, as well as a number of other synthetic carbonaceous products, utilizing Fischer-Tropsch processes. Fischer-Tropsch processes are well known and have been used for many years to convert synthesis gas mixtures into materials as varied as ethanol, heavy paraffins, olefins, and similar products.

A process for the production of ethanol from biomass material is described in International Publication WO2005/021474A1. This publication was filed by Stanley R. Pearson on Aug. 20, 2004, as a PCT application claiming priority from U.S. provisional applications 60/496,840 and 60/534,434, filed Aug. 21, 2003 and Jan. 6, 2004, respectively. WO2005/021474A1 discloses a process, including a biomass feed-treating process, a reformer process for converting biomass to synthesis gas, and a process for converting a synthesis gas into ethanol. A similar process is disclosed in WO/2005/021421A2, filed by Stanley R. Pearson as a PCT application on Aug. 20, 2004, claiming priority from U.S. provisional applications 60/496,840 and 60/534,434, filed Aug. 21, 2003 and Jan. 6, 2004, respectively. Both of these publications are hereby incorporated in their entirety by reference.

An essential component of all such processes is the need to convert a biomass material, which may be highly cellulosic, into synthesis gas. Various types of reactors have been proposed but have been found to have many shortcomings, such as a short useful service life, ineffective conversion, inefficient conversion, or excessive conversion process complexity. Accordingly, a continuing effort has been directed to the development of an improved reformer that is relatively simple, but highly effective in reforming biomass material to synthesis gas.

### SUMMARY OF THE INVENTION

According to the present invention, a reformer is provided for converting biomass into synthesis gas comprising primarily of carbon monoxide, hydrogen, and carbon dioxide by reaction with steam. The reformer consists of a cylindrical vessel with an outer wall having an inside and an outside, a bottom and a top, a biomass inlet, and a synthesis gas outlet. It also includes a tubular reactor in the cylindrical vessel, the tubular reactor being in fluid communication with the biomass inlet and the synthesis gas outlet; a radiant section extending upward from the bottom of the cylindrical vessel; a burner centrally positioned in the bottom of the cylindrical vessel; at least one outer section having an inside, a top, and a bottom and positioned on the cylindrical vessel outer wall over an opening in the cylindrical vessel outer wall along at least a portion of the axial length of the tubular reactor, along a central axis of the cylindrical vessel; and at least one burner positioned in the bottom of at least one outer section.

### BRIEF DESCRIPTION OF THE DRAWINGS

FIG. 1 is a schematic view of the reactor of the present invention;

FIG. 2 is a top view of the reactor taken at lines AA on FIG. 1; and;

FIG. 3 is a schematic diagram of a system for the production of a suitable biomass feed for the reactor of the present invention.

### DESCRIPTION OF PREFERRED CHARACTERISTICS

In the discussion of the FIGs of the present invention, the same numbers have been used throughout to refer to the same or similar components.

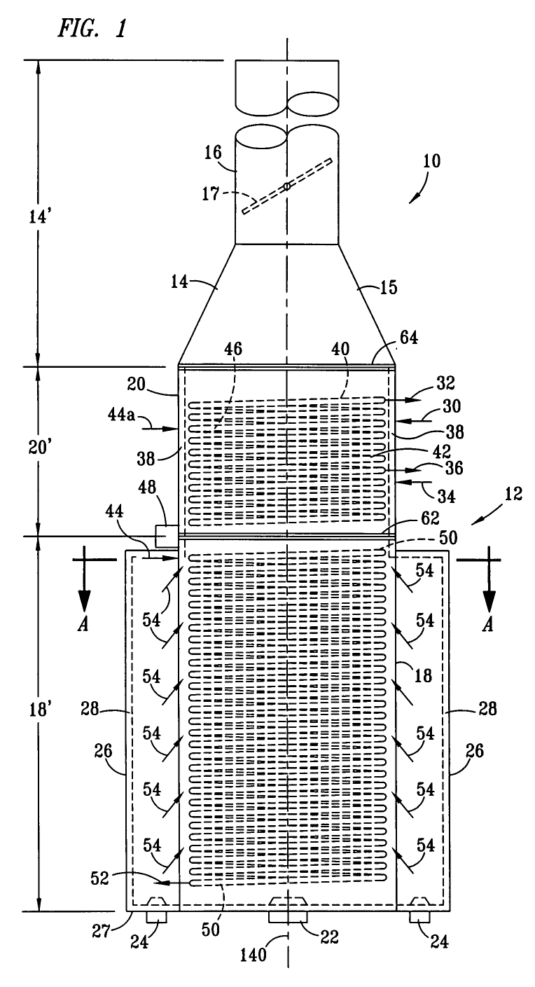

On FIG. 1, biomass reformer 10 is shown and consists of a cylinder 12, including a stack 16 and a transition section 14 for the discharge of combustion gases from the reformer; it also includes a tapered section 15, stack 16, and dimension lines defining a height 14 of the transition and stack section, as shown. The height of this section can vary widely. Typically, stack 16 also includes a flow controller, shown as a damper 17. This flow controller provides a desired back pressure in the reactor and regulates the amount of combustion gas discharged from the reactor.

Convection section 20 is shown above a radiant section 18. In radiant section 18, a tubular reactor consisting of multiple tube coils 50 is shown. The tubular reactor can be fabricated of any suitable material and is used to receive a feed of biomass entrained in a stream of steam via a line 44. The mixture of biomass and steam is passed rapidly through the tubular reactor and is discharged at a synthesis gas outlet 52. This gas stream is subsequently passed to cooling, scrubbing, or solids separation units (as required) to remove the nonreactive materials of the biomass from the synthesis gas. As well known to those in the industry, the hydrogen to carbon monoxide ratio of the synthesis gas may be adjusted by the use of, for example, the water gas shift reaction. The technology for performing this change is well known, as is the technology for converting synthesis gas into a wide range of products utilizing, for example, the Fischer-Tropsch process.

The tubes in the radiant portion of the biomass reformer should be fabricated of materials that can withstand temperatures in excess of about 1900° F. and may include materials such as B407UNSN8810 alloy steel or equivalent. The tubes in the convection section of the reformer should be fabricated of carbon steel and high temperature alloy steel such as A312TP310 alloy or equivalent. A variety of alloy steels are available for use in the hottest portions of the reformer. The tubular reactor may also consist of multiple tube coils 50, which may have numerous inlets and outlets. Such variations are well known in the industry and do not require further elaboration. Alternatively, the tubes may be arranged in other configurations that are effective for heating by a central burner 22, as shown.

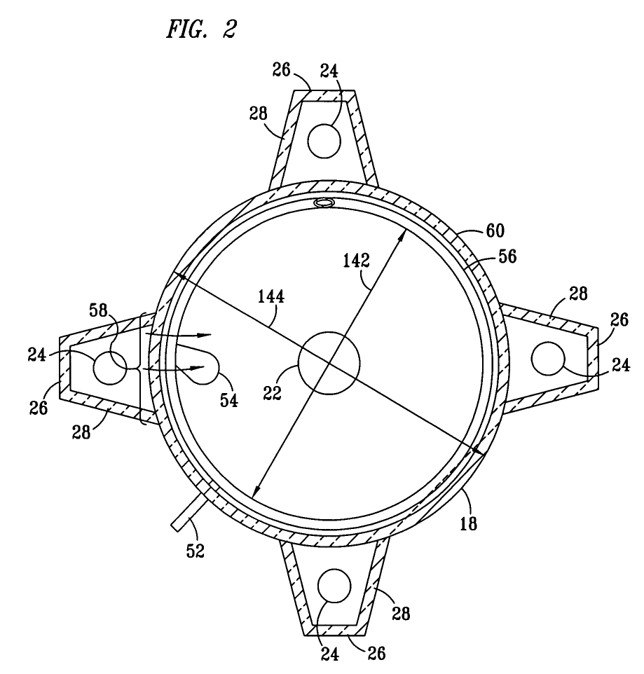

Previous reactors have been generally effective, but have shown some tendency to be ineffective with respect to the distribution of heat to the outside of the coiled tube reactor. According to the present invention, this shortcoming is overcome by the use of at least one and preferably four outer sections 26 positioned over openings 54 (shown on FIG. 2) covered by the outer sections. Preferably, the outer sections are internally also lined with a refractory insulation 38, which may be any suitable refractory material that is capable of withstanding temperatures up to about 2500° F.

These outer sections include burners 24, which produce heated gas that passes, as shown by arrow 54, from the inside of outer sections 26 into cylindrical section 12 in radiant section 18, to effectively heat the outside of the reactor tubes and substantially increase the efficiency of the radiant heat section. As shown, the bottom 27 of the outer sections is at essentially at the same level as the bottom of radiant section 18. Burner 24 is basically at the same level as burner 22, so that the gases produced from the burners effectively contact the tubular reactor along the entire length of opening 54 to increase the heat provided to the tubular reactor.

FIG. 2 is a top view of the reactor shown in FIG. 1 taken at line A-A. FIG. 2 shows the inner diameter of the coil, the outer sections and the inner diameter of the reactor cylinder. The outer sections are shown with insulation 28.

In a variation of the present invention, the feed stream may be introduced through a line 44a into a feed preheat coiled tube reactor 46 in convection section 20, so that the biomass feed and steam stream are passed through preheating coil section 46 to preheat the biomass/steam mixture in the convection section, with the combined streams being passed via a line 48 from the convection section into the radiant section for reaction. Furthermore, as shown, steam production coil 40, with water inlet 30 for the production of steam through line 32 and a steam coil 42 for introducing steam through line 36 for the production of superheated steam through line 34, is included in the convection section. The convection section includes steam generator coil 40 to reduce the temperature of the flue gases passed to stack 16. The super-heating of steam and the preheating of the biomass/steam is adjusted as required to produce the desired inlet temperature for the biomass/steam stream passed into the radiant section. This temperature ranges from about 950° F. to about 1250° F. The amount of steam produced is sufficient to cool the combustion gases that pass into transition section 15 to a temperature below about 600° F. and preferably below about 550° F.

The residence time of the biomass/steam—synthesis gas mixture in the tubular reactor, i.e., coils 50 can vary significantly and is typically from about 0.6 second to 2 seconds, with the outlet temperature from the reactor being from about 1500° F. to 1800° F. Variations of temperature and time in the reactor can result in the production of synthesis gas having different hydrogen/carbon monoxide ratios.

The amount of preheating of the feed stream achieved in convection section 20 can vary widely. The amount of water in the biomass, for instance, may be insignificant if the biomass has been adequately dried previously and is charged with superheated steam that will continue to reduce the amount of water in the biomass stream. Typically, the water concentration of the biomass stream is reduced to a level of about 20 weight percent or less and, preferably, to a level of about 15 weight percent or less, prior to charging to the convection section.

As shown in WO/2005/021474, the biomass may simply be passed into a stream of flowing superheated steam for transportation to and through the tubular reactor. No reactor is shown in detail in WO/2005/021474, and certainly no reactor with the efficiency and longevity provided by the structure of the reformer described herein.

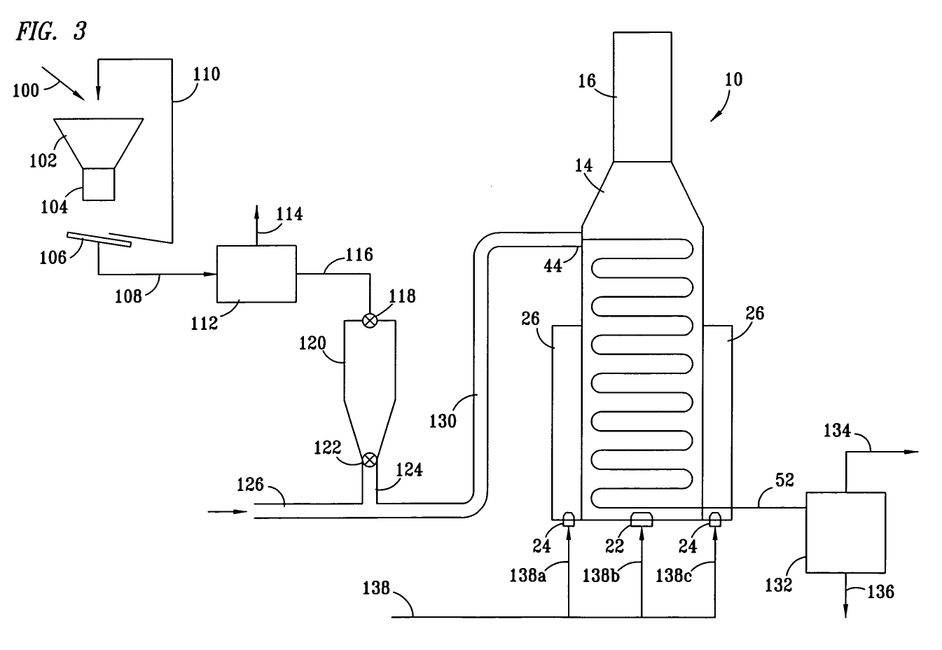

The preparation of feed for the reformer is shown on a schematic diagram on FIG. 3. On this FIG, biomass feed is introduced into a hopper 102 (as shown by arrow 100), passed downward through hopper 102 to a grinder 104, which grinds the biomass feed to a fine consistency and drops it onto a screen 106. Biomass from grinder 104 that is not sufficiently fine is recycled by a line 110 back to hopper 102. The finely divided particles from screen 106 are routed through line 108 and passed to dryer 112, with exhaust gases being filtered and vented through line 114. The dried biomass material is then passed via a line 116 and a lock valve 118 to storage in a hopper 120, from which it is passed via a second lock valve and a metering system 122 through a line 124 to be combined with a superheated steam by entraining it in a steam stream supplied through a line 126. The resulting mixture passes through line 130 to the reformer of the present invention through feed inlet 44. The fuel for burners 22 and 24 is supplied as shown via a line 138 and may comprise a fuel gas, synthesis gas, or any combustible gas or liquid fuel stream.

The resulting synthesis gas is routed via line 52 to treatment in a facility 132, where it may be quenched, cooled, or treated for the removal of solids, sulfur, heavy hydrocarbons, and other impurities with the waste material being passed via a line 136 for further treatment and with the treated synthesis gas being recovered through a line 134. The synthesis gas may also be adjusted in this section to achieve a desired hydrogen-to-carbon monoxide ratio, or the adjustment may occur through further processing.

The techniques for treating and charging a dried biomass material to the reformer of the present invention form no part of the present invention; any one of a number of well known, established processes may be used. For instance, U.S. Pat. No. 6,767,375, issued Jul. 27, 2004, to Larry E. Pearson and U.S. Pat. No. 6,972,114, issued Dec. 6, 2005, to LeRoy B. Pope, et al., describe processes for handling biomass, as does WO/2005/021474.

The present invention consists of a reactor that is particularly effective and efficient in supplying heat to the radiant section and to the convection section of a tubular reactor.

Typically, the reformer of the present invention receives a feedstock at temperatures from about 250° F. to about 450° F. at inlet 44a. The temperature of the synthesis gas leaving the reactor is typically between about 1500° F. and 1800° F. A preferable temperature is about 1650° F. up to about 1750° F. The pressure in reformer 10 can vary widely, as long as the pressure in the tubular reformer is sufficient to move the biomass through the tubular reformer at the desired rate. The temperature and pressure conditions, as well as the steam to biomass ratios, will vary dependent on the particular feedstock available to obtain the desired hydrogen to carbon monoxide ratio. Individuals familiar with these processes can readily determine the operating conditions for a particular feed stream. Contact times in the tubular reactor vary from about 0.4 second to 2.5 seconds; 0.6 second to 2 seconds is preferred.

The amount of superheated steam used is a function of the nature of the feedstock. Skilled technicians can readily determine the hydrogen and carbon content of the feedstock, as well as the amount of water contained in the feedstock, for the purposes of determining the proper ratio of superheated steam to be combined with the biomass feedstock. As indicated previously, the product synthesis gas stream can be treated for the removal of undesirable materials such as oils, solids, or acidic components.

The reformer sections, i.e., radiant section 18, convection section 20, and stack and transition section 14, are shown as separate sections connected at 62 and 64. The reformer could also be fabricated as a single unit or in sections to be assembled to produce the reformer.

While the present invention has been described by reference to some of its preferred characteristics, it should be noted that the characteristics described are illustrative rather than limiting in nature and that many variations and modifications are possible within the scope of the present invention. Many such variations and modifications may be considered obvious and desirable by skilled technicians, based on a review of the previous description.

What is claimed:

1. A reformer for converting biomass into synthesis gas comprising primarily carbon monoxide, hydrogen, and carbon dioxide by reaction with steam, the reformer comprising the following:
a) a cylindrical vessel with an outer wall having an inside and an Outside, a bottom and a top, a biomass inlet and a synthesis gas outlet and including a tubular reactor in the cylindrical vessel, the tubular reactor being in fluid communication with the biomass inlet and the synthesis gas outlet;
b) a radiant section extending upward from the bottom of the cylindrical vessel;
c) a burner centrally positioned in the bottom of the cylindrical vessel;
d) at least one outer section having an inside and a top and a bottom and positioned on the cylindrical vessel outer wall over an opening in the cylinder outer wall along at least a portion of the axial length of the reformer; and,
e) at least one burner positioned in the bottom of at least one outer section.

2. The reformer of claim 1, wherein the cylindrical vessel includes a convection section above the radiant section.

3. The reformer of claim 1, wherein the tubular reactor extends into the convection section.

4. The reformer of claim 1, wherein the tubular reactor comprises at least one coiled tube reactor coiled to a diameter slightly smaller than an inner diameter of the inside of the outer wall of the cylindrical vessel.

5. The reformer of claim 1, wherein the tubular reactor comprises multiple coiled tube reactors.

6. The reformer of claim 1, wherein multiple outer sections are positioned over numerous openings in the cylinder vessel.

7. The reformer of claim 1, wherein at least a portion of the inside of at least one outer section is covered by an insulating material.

8. The reformer of claim 1, wherein at least a portion of the inside of at least one outer section is covered by an insulating reflective ceramic coating.

9. The reformer of claim 1, wherein the reformer further includes a stack and transition section positioned above the convection section.

10. The reformer of claim 9, wherein the stack includes a gas flow regulator.

11. The reformer of claim 1, wherein heat recovery coil systems are positioned in the convection system to recover heat from the convection system.

12. The reformer of claim 1, wherein at least a portion of the heat recovery systems produce steam and super-heated steam.

13. The reformer of claim 1, wherein the tubular reactor comprises multiple coiled tube reactors, with at least a portion of the coiled tube reactors having a biomass/steam inlet and a synthesis gas outlet.

14. The reformer of claim 1, wherein the biomass comprises, but is not limited to, lignite, coal, wood, bagasse, rice hulls, sawgrass, kenaf, sewer sludge, motor oil, oil shale, creosote, pyrolysis oils, railroad ties, grains, cornstalks, and cobs.

15. The reformer of claim 1, wherein the outlet gas temperature from the tubular reactor is from about 1500° F. to about 1800° F.

16. The reformer of claim 1, wherein the temperature of the gases discharged through the stack is below about 600° F.

17. The reformer of claim 1, wherein the residence time of the biomass/steam in the tubular reactor is from about 0.4 second to about 2.5 seconds.

18. The reformer of claim 1, wherein the radiant section, the convection section, and the stack and transition sections comprise separate components joined together to form the reformer.
